(19) United States
(12) Patent Application Publication
(10) Pub. No.: US 2007/0011041 A1
(43) Pub. Date: Jan. 11, 2007

(54) Systems and methods for communicating within a supply chain

(76) Inventor: David Bourne, Roswell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/482,544

(22) Filed: Jul. 7, 2006

Related U.S. Application Data
(60) Provisional application No. 60/697,427, filed on Jul. 7, 2005.

(51) Int. Cl. G07G 1/00

(52) U.S. Cl. 705/10; 340/5.9; 340/572.1; 340/10.1

(57) ABSTRACT

Generally described, embodiments of the present invention provide systems and methods for facilitating communication within a supply chain. In one embodiment of the present invention, a supplier places RFID tags on containers holding product or items for shipment to a customer. When a customer depletes the product or items in the container, the RFID tag associated with the container is read by an RFID interrogator. Software associated with the RFID interrogator places an order with the supplier for replenishment of the product or items held in the container. In a further embodiment, an RFID tag is provided for communicating a need for technical assistance from a supplier. In this embodiment, an RFID tag associated with an outside company having technical expertise is made available to technicians at the customer's facility. If a need arises for technical assistance, the technician positions the tag so that it can be read by an RFID interrogator. Software associated with the RFID interrogator sends a request or alert to the outside company who responds accordingly.

### CROSS-REFERENCE TO RELATED APPLICATIONS

The present application claims the full benefit and priority of pending U.S. provisional patent Application No. 60/697,427, filed Jul. 7, 2005, entitled “Systems and Methods for Communicating Within A Supply Chain.” The entire contents of this provisional application are incorporated by reference.

### FIELD OF THE INVENTION

The present invention generally relates to systems and methods for facilitating communication within a supply chain. More particularly, the present invention relates to using RFID technology to communicate the needs of a customer to a supplier.

### BACKGROUND

Close communication between a supplier and their customer is critical to the efficient workings of any supply chain. This is particularly true when a customer's inventory of a necessary product is nearly depleted. Often, a customer will track their inventory levels by scanning barcodes placed on the various inventory items to ensure adequate quantities are on hand. Although barcode systems have worked reasonably well in some environments, these systems have several limitations. For example, if the items are used in a dirty environment, the barcode itself is often obscured by dirt or grime.

Recently, some manufacturers have attempted to use RFID tags as a replacement for barcode labels. These tags use radio frequency (“RF”) signals to communicate information and therefore, do not require a line of site to transmit information. Additionally, the tags are less susceptible to problems associated with dirty environments or barcodes damaged due to abrasion. However, communicating with these tags is unreliable if the tags are placed on metal containers or on containers holding liquid because metal deflects the radio frequency signals and liquids absorb the signals.

In some industries, such as collision repair, the inventory levels of a repair shop are maintained by a supplier or jobber. The jobber sends a representative to the repair shop to check the inventory levels of various products and reorders inventory items as necessary. To place the order, the representative may simply call it in or in more sophisticated systems, the representative scans the necessary items and an order is automatically placed via a wireless connection. But, dedicating an individual to travel between customers is an excessively expensive process for reordering inventory items.

Therefore, a need exists for systems and methods that communicate needs within a supply chain that overcome deficiencies in the prior art, some of which are identified above.

### BRIEF SUMMARY OF THE INVENTION

To address deficiencies in the current state of the art, some of which are discussed above, the present invention provides improved systems and methods for communicating within a supply chain. Embodiments of the present invention RFID technology to communicate needs of a customer to a supplier.

In one embodiment, a replenishment system is provided. This system includes: an order fulfillment system configured to associated an RFID tag with a product that interferes with the transmission of radio signals; and a reorder system which itself includes an RFID interrogation device configured to read the RFID tag after it has been removed from the product; and a reorder computer configured to place an order for replenishment of the product based in part on the interrogated RFID tag.

In a further embodiment, a method of replenishing a product is provided. This method includes the steps of: receiving a metal container holding the product with an associated RFID tag; placing the container in inventory; retrieving the container from inventory as needed; removing the RFID tag such that the RFID tag can be read by an RFID interrogator; interrogating the RFID tag; and placing an order for replacement quantities of the product based at least in part on the interrogating step.

In another embodiment, an apparatus for interrogating RFID tags is provided. This apparatus includes an enclosure having a removeable lid and an aperture sized to accept an RFID tag; an RFID interrogator positioned inside the enclosure; and a receptacle positioned inside the box and configured to accept RFID tags after they are interrogated.

In another embodiment, a system for providing technical assistance is provided. This system includes: an RFID tag associated with an entity capable of providing technical assistance; an RF signal shielding device configured to selectively prevent the RFID tag from being read; an RFID interrogator configured to detect when the RFID tag has been removed from the shielding device; and a contact computer associated with the RFID interrogator and configured to send a message to the entity based at least in part on communication between the RFID interrogator and the RFID tag.

In a further embodiment, a system for providing technical assistance is provided. This system includes a plurality of RFID tags associated with a plurality of entities capable of providing technical assistance; a plurality of RF signal shielding devices configured to selectively prevent the plurality of RFID tags from being read; an RFID interrogator configured poll the RFID tags and to identify a select RFID tag when the select RFID tag has been unshielded; and a contact computer associated with the RFID interrogator and configured to send a message to an entity associated with the select RFID tag based at least in part on communication between the RFID interrogator and the RFID tag.

In another embodiment, a method of requesting technical assistance is provided. This method includes the steps of: associating an RFID tag with a entity capable of providing technical assistance; shielding the RFID tag to selectively prevent interrogation of the RFID tag; unshielding the RFID tag to allow the RFID tag to be interrogated; and sending a message to the entity based at least in part on the interrogation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic drawing of a replenishment system 10 in accordance with an embodiment of the present invention

FIG. 2 illustrates an embodiment of a reorder system 32 in accordance with the present invention.

FIG. 3 is a schematic drawing illustrating an RFID tag 26 passing through an RFID interrogator 33 in accordance with an embodiment of the present invention.

FIG. 4. is a schematic drawing of an exemplary architecture of a computer in accordance with an embodiment of the present invention.

FIG. 5. is a flow diagram illustrating exemplary method steps for use of a reordering system in accordance with an embodiment of the present invention.

FIG. 6 is a schematic drawing illustrating a “Call for help” system in accordance with an embodiment of the present invention.

FIGS. 7a-c are drawings of exemplary shielding devices in accordance with embodiments of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

General Description

Generally described, embodiments of the present invention provide systems and methods for facilitating communication within a supply chain. More particularly, embodiments described herein utilize RFID technology to communicate needs of a customer to a supplier.

In one embodiment of the present invention, a supplier places RFID tags on containers holding product or items shipped to a customer. When the customer uses the product or items in the container, the RFID tag associated with the container is read by an RFID interrogator. A computer associated with the RFID interrogator places an order with the supplier to replenish product or items. In one embodiment, the product is provided in a container that interferes with transmission of RF signals such that communication with the RFID tag is unreliable. This is addressed by removing the tag from the container to facilitate interrogation. This novel system provides an efficient means for communicating replenishment needs that overcomes some of the deficiencies in prior systems.

In a further embodiment of the present invention, RFID technology is used to communicate a need for technical assistance from a supplier. In one embodiment, an RFID tag associated with an outside company having technical expertise is made available to individuals at the customer's facility. If a need arises for technical assistance, the individual positions the RFID tag so that it can be read by an RFID interrogator. A computer associated with the RFID interrogator sends a request or alert to the outside company who responds accordingly. In one embodiment, the outside company contacts a designated individual at the customer's location in response to the alert. This provides an easy way for a technician to obtain technical assistance.

RFID Technology

Radio frequency identification technology uses radio waves rather than optics to capture and transmit data. RFID is basically a form of labeling where electronic labels or tags are programmed with unique information and attached to objects to be identified or tracked. With RFID, electronic chips are used to store data that can be broadcast via radio waves to a reader, thereby eliminating the need for a direct line of sight and making it possible for tags to be placed virtually anywhere. Additional benefits of RFID are the greater data storage capacity of the RFID tag in comparison to the barcode and the decreased likelihood that the RFID tag will be destroyed or otherwise made unreadable.

A typical RFID system consists of a reader, a tag and a data processing system to process the data read from the tag. The tag also is called a transponder, an expression that is derived from TRANSmitter/resPONDER and, in some cases, the term tag is used for low-frequency (e.g. 125 kHz), whereas the term transponder is used for high-frequency (e.g. 13.56 MHz and 2.45 GHz) tags. But for purposes of this application the terms tag and transponder are used interchangeably. The complexity of the reader (sometimes referred to herein as an interrogator) can vary considerably, depending on the type of tag used and the function to be fulfilled. In general, a reader has radio circuitry to communicate with a tag, a microprocessor to check and decode the data and implement a protocol, a memory to store data and one or more antennas to receive the signal. Readers may be configured to communicate with tags within a near field range of one to three feet or a far field range of ten to twenty-five feet.

Unlike a barcode reader, which is limited to reading a single barcode at a time, a RFID reader may have more than one tag in its interrogation zone. The interrogation zone, as that term is used herein, refers to the area covered by the magnetic field generated by the reader's antenna. The process of reading a number of transponders within a system's interrogation zone is known as batch reading. Software applications known as anti-collision algorithms exist that permit a reader to avoid data collision from several tags that enter the interrogation zone at the same time. One of three different anti-collision techniques is generally implemented; these techniques are spatial, frequency and time domain procedures.

In the spatial domain technique, the reader restricts its interrogation zone in order to reduce the possibility that two different transponders fall into the area covered by the reader itself. With this technique, the number of readers needed to cover an area increases in proportion to the size of the covered area.

Frequency domain procedures are based on frequency domain multiplex techniques or spread spectrum technologies. In these systems, the reader broadcasts a status of frequencies allocated to the communication with the transponders, with frequencies flagged that are currently in use by a transponder. When a new transponder accesses the reader's coverage, it uses an unoccupied frequency to transmit its data.

Time domain anti-collision techniques are divided into two categories: interrogator and transponder driven procedures. In addition, interrogator driven time domain anti-collision procedures can be sub-divided into polling and binary search procedures. Polling techniques make use of the fact that a unique serial number is written to each transponder at the production stage. In the polling technique, the interrogator requests all possible transponder serial numbers until a transponder with a polled serial number responds. The polling procedure is typically slow and generally is limited to processes employing small numbers of transponders. The other interrogator driven procedure is the binary search. A binary search is faster than the polling technique, and is based on search algorithms that use binary trees of transponder identifiers. In the transponder driven anti-collision procedures, the transponder, rather than the interrogator, controls the data flow. In general, transponder driven procedures are based on the cyclic transmission of identifiers by transponders and are designed such that it is unlikely that any two transponders will send the same identifier at the same time.

RFID tags may be active or passive depending on whether they have an on-board power source or not. In general, active tags use batteries to power the tag transmitter (radio) and receiver. This independent power source provides greater capabilities such as, for example, greater communication ranges, better noise immunity and higher data transmission rates than passive tags. But, these tags usually contain a greater number of components than do passive tags and therefore, are usually larger in size and are more expensive than passive tags. In addition, the life of an active tag is directly related to battery life.

In contrast, a passive tag reflects the RF signal transmitted to it from a reader and adds information by modulating the reflected signal. A passive tag does not use a battery to boost the energy of the reflected signal. But, a passive tag may use a battery to maintain memory in the tag or power the electronics that enable the tag to modulate the reflected signal. Passive tags have virtually unlimited life, but have shorter read ranges and require high-powered readers.

ReOrder System

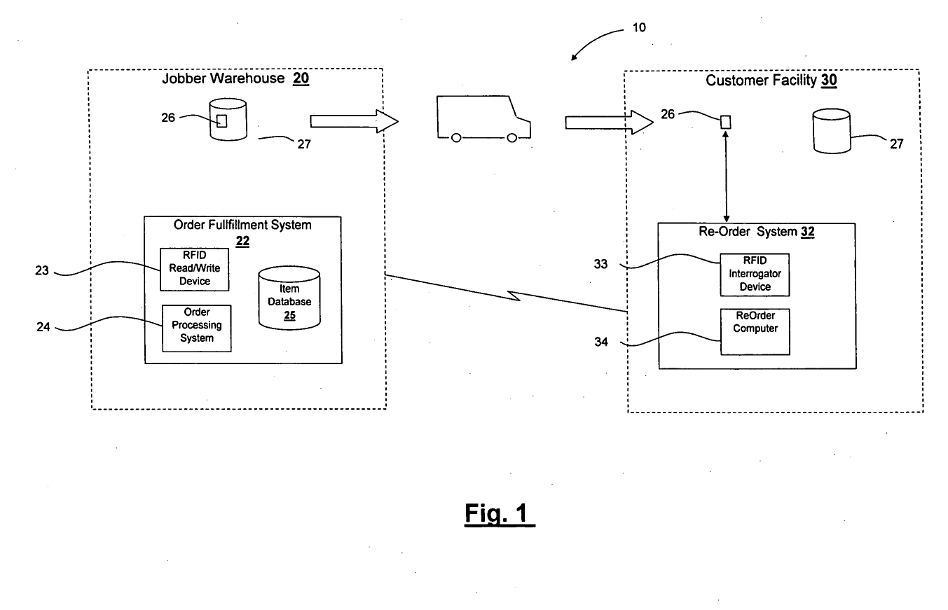

With reference to FIG. 1, an embodiment of the Replenishment System 10 provides a means for communicating replenishment needs from a customer to a suppler. The system 10 includes components at the supplier or jobber warehouse 20 and at the customer's facility 30.

At the jobber's warehouse 20, an order fulfillment system 22 is provided that includes an RFID read/write device 23, an Order Processing System 24 and an item database 25. The RFID read/write device 23 is configured to associate an RFID tag 26 with a container 27 holding a specific item or product. In one embodiment, the RFID read/write device 23 is configured to program the RFID tag 26 with the item number for the ordered item. Alternatively, the RFID read/writer 23 may read the RFID tag's unique identification number and associate that number with the ordered item's part number in the item database 25. In a further embodiment, the RFID tag may also include indicia encoding the unique identification number programmed into the tag. The indicia may be a barcode, Maxicode or other encoding indicia.

The Order Processing System 24 includes one or more computers configured to receive order information from customers and to generate documents necessary to fulfill the order such as shipping manifests and invoices. In one embodiment, the Order Processing System 24 receives an RFID tag's unique identification number from the customers reorder system 32. Using this information, the Order Processing System 24 may query the item database 25 to determine the product needing replenishment. Alternatively, the information sent may indicate the actual product needing replenishment.

At the customer facility 30, a reorder system 32 is provided that includes an RFID interrogator 33 and a reorder computer 34. The RFID interrogator is configured to read the RFID tag after it is removed from the container 27. The read information is then communicated to the reorder computer 34, which, in turn, communicates the information to the order processing system 24. The reorder computer 34 may process the information to identify the product needing replenishment. Alternatively, the RFID interrogator 33 may communicate directly with the Order Processing system 24. This communication may be via LAN, WLAN, the Internet, or other communication method known or developed. In this alternatively embodiment, a reorder computer 34 at the customer facility is not necessary.

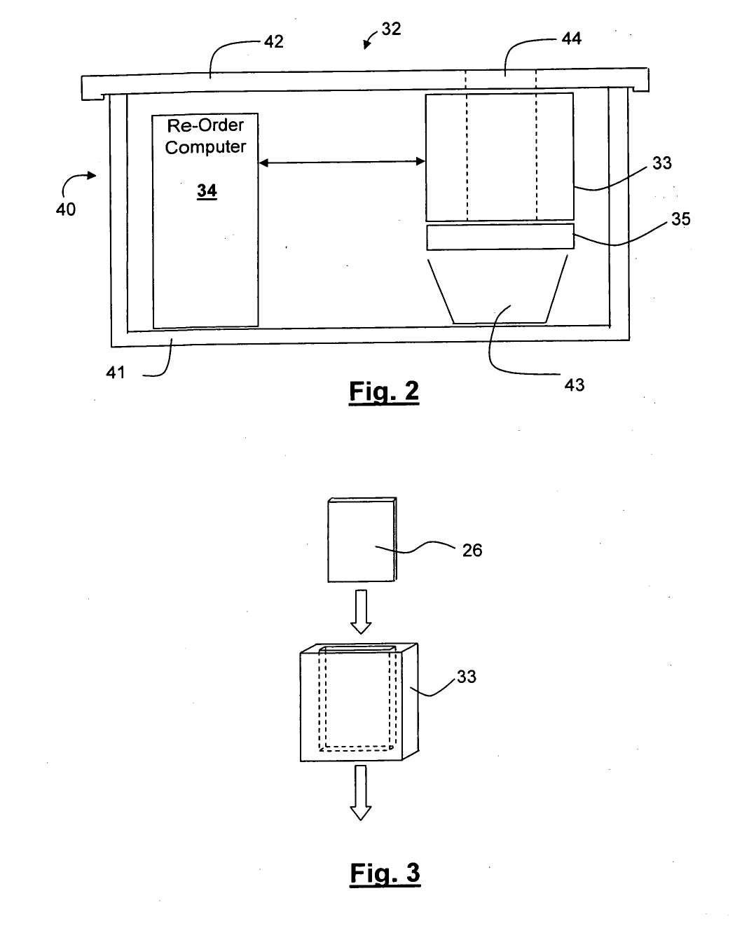

FIG. 2 illustrates an embodiment of the reorder system 32. This embodiment includes a reorder computer 34, an RFID interrogator 33 and an enclosure 40 having a body portion 41 and a lid portion 42. Preferably, the lid portion 42 includes a slot 44 or other shaped aperture sized to accept the RFID tag and to guide the tags proximate the RFID interrogator 33 to facilitate interrogation of the tag. In the illustrated embodiment, the slot is positioned in the lid 42, however, as will be appreciated by those of skill in the art, the slot 44 may be positioned anywhere on the enclosure 40 as desired.

A benefit of the enclosure embodiment is that it provides protection from the work environment for both the interrogator 33 and the reorder computer 34; however, as one of ordinary skill in the art will appreciate, any configuration of RFID interrogator and reordering computer may be utilized with the present invention. For example, the RFID interrogator 33 could be a handheld device that communicates with the reordering computer 34 using wireless signals. Alternatively, the enclosure 40 may house only the RFID interrogator 33 at one location and the reorder computer 34 could be positioned at a separate location. Communication between the devices could be via line connection or wireless signals. In a further embodiment, the RFID interrogator 33 is positioned above the enclosure body portion 41 without the lid 42 such that after a tag is read, it drops into the enclosure body portion 41. A receptacle 43 may also be provided to collect the read tags.

An exemplary RFID interrogator 33 is shown in FIG. 3 where the RFID tag passes through a slot 44. However, as one of ordinary skill can appreciate, any type of RFID interrogator will work in connection with the present invention. For example, the RFID interrogator may not include a slot and the RFID tag is read by simply passing the tag near the RFID interrogator.

In the illustrated embodiment, an RFID disabling device 35 is also present. This device disables the RFID tag after it has been read by the RFID interrogator 33. In one embodiment, this device is configured to produce a high energy RF signal such that the RFID circuitry is burned out. In an alternative embodiment, this device physically destroys the tag such as a document shredder. In a further embodiment, the device simply places indicia on the tag to indicate such as an ink stamp or printed indicia.

Replenishment orders are placed by the reorder computer 34 to the fulfillment system 22 at the jobber warehouse 20. The replenishment order may include the unique identification numbers for the RFID tags read and/or data indicating the actual product being ordered such as a part number. The order information may be communicated via the Internet, intranets, LANs, or other data communication method.

Although FIG. 1 shows the reorder computer 34 located at the customer facility, one of ordinary skill in the art will appreciate that the computer may be located in several different locations. For example, the functions of the reorder computer may be performed by the order processing system at the jobber warehouse 20. In one embodiment, the functions of both the order processing system 24 and the reorder computer are performed by the same computer system at the jobber warehouse 20. In which case, the Reorder System 32 at the customer facility 30 would be configured to transmit the RFID tag information to the order fulfillment system.

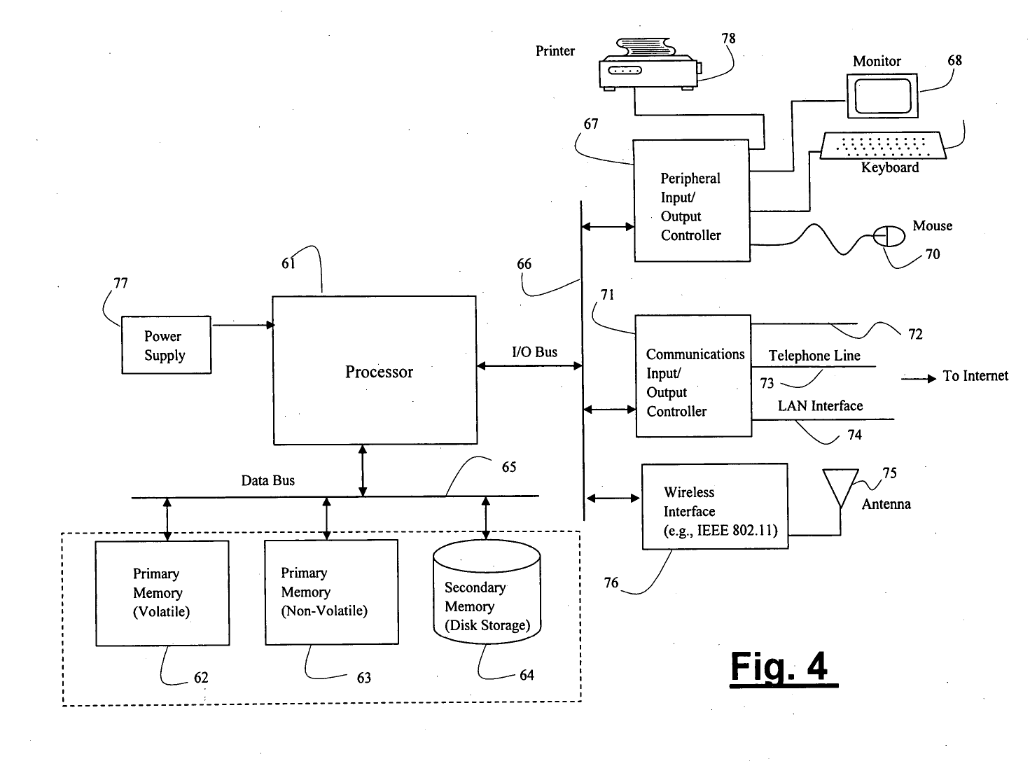

The general architecture and capabilities of the reorder computer 34 and the order processing system 24 will now be described with reference to FIG. 4. A processor 61, such as a microprocessor, is used to execute software instructions for carrying out defined steps. The processor receives power from a power supply 77 that also provides power to the other components as necessary. The processor 61 communicates using a data bus 65 that is typically 16 or 32 bits wide (e.g., in parallel). The data bus 65 is used to convey data and program instructions, typically, between the processor and memory. In the present embodiment, memory can be considered primary memory 62 that is RAM or other forms which retain the contents only during operation, or it may be non-volatile 63, such as ROM, EPROM, EEPROM, FLASH, or other types of memory that retain the memory contents at all times. The memory could also be secondary memory 64, such as disk storage, that stores large amount of data. In some embodiments, the disk storage may communicate with the processor using an I/O bus 66 instead or a dedicated bus (not shown). The secondary memory may be a floppy disk, hard disk, compact disk, DVD, or any other type of mass storage type known to those skilled in the arts.

The processor 61 also communicates with various peripherals or external devices using an I/O bus 66. In the present embodiment, a peripheral I/O controller 67 is used to provide standard interfaces, such as RS-232, RS422, DIN, USB, or other interfaces as appropriate to interface various input/output devices. Typical input/output devices include local printers 78, a monitor 68, a keyboard 69, and a mouse 70 or other typical pointing devices (e.g., rollerball, trackpad, joystick, etc.).

The processor 61 may also communicate using a communications I/O controller 71 with external communication networks, and may use a variety of interfaces such as data communication oriented protocols 72 such as X.25, ISDN, DSL, cable modems, etc. The communications controller 71 may incorporate a modem (not shown) for interfacing and communicating with a standard telephone line 73. Finally, the communications I/O controller may incorporate an Ethernet interface 74 for communicating over a LAN. Any of these interfaces may be used to access the Internet, intranets, LANs, or other data communication facilities. These communication methods may be used to replenishment information to the jobber's system.

Finally, the processor 61 may communicate with a wireless interface 76 that is operatively connected to an antenna 75 for communicating wirelessly with another devices, using for example, one of the IEEE 802.11 protocols, 802.15.4 protocol, or a standard 3G wireless telecommunications protocols, such as CDMA2000 1x EV-DO, GPRS, W-CDMA, or other protocol. In some embodiments, the reorder computer communicates with the RFID interrogator using wireless protocols.

Those skilled in the art of data networking will realize that many other alternatives and architectures are possible and can be used to practice the principles of the present invention. The embodiments illustrated in FIG. 4 can be modified in different ways and be within the scope of the present invention as claimed.

Exemplary Methods of Use for the ReOrder System

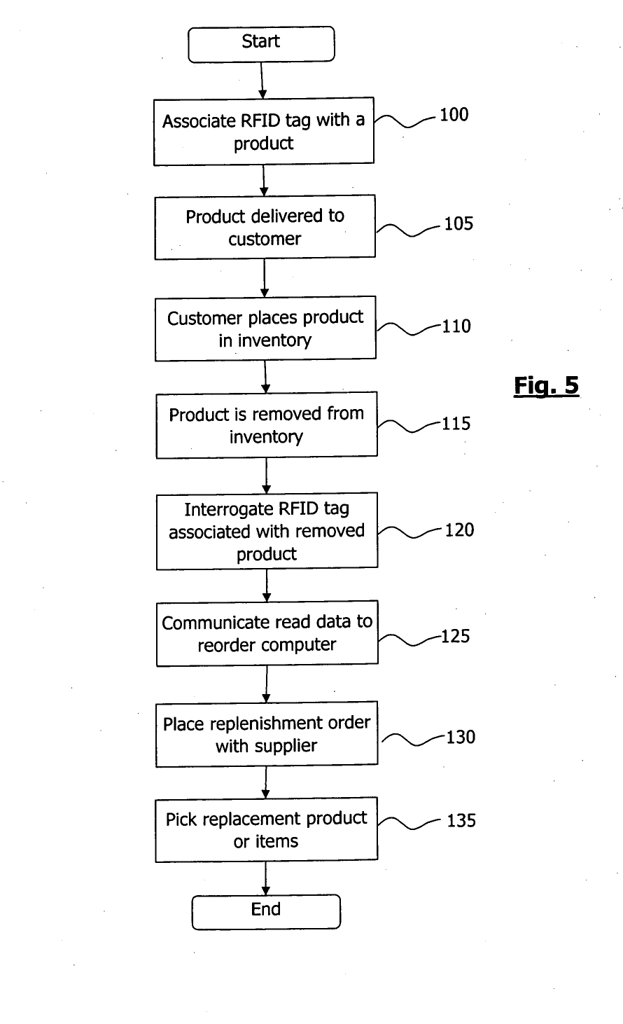

An exemplary method of use for the Reorder System 10 is generally illustrated in FIG. 5. The exemplary methods described below will generally refer to a collision repair facility and a jobber for ease of understanding, but as will be appreciated by one of ordinary skill in the art, embodiments of the present invention may be used in connection with any customer and any individual or company selling products. The individual may be a customer's employee stationed at a remote location or an employee of a third party.

The process begins at Step 100 where the jobber associates RFID tags with a container of product such as tint. Tint is a liquid substance added to paint by a collision repair shop to achieve a desired color. It is typically stored in metal containers, and therefore, RFID tags affixed to these containers are difficult to read because the metal containers deflect RF signals and the liquid tint absorbs RF signals.

To associate the RFID tag 26 with the tint held by the container 27, the tag 26 is preferably programmed with a description of the tint and a part number. Alternatively, the tag 26 may be identified by a unique identification code, which when read by the RFID read/write 23 device may be associated with the item description and part number in the item database 25. In a further embodiment, the RFID tag includes human readable and machine readable (e.g., barcode, Maxicode, etc.) indicia that provide product descriptions or part numbers or both. This provides a backup method of obtaining the necessary information if the RFID portion of the tag is damaged, or an RFID interrogator is not available.

After associating the RFID tag 26 with the product (which is tint in this embodiment), the tag is secured to the container 27 by inserting it into a plastic sleeve affixed to the container 27. However, it should be understood that the RFID tag 26 may be secured to the container 27 in any manner such as releasable adhesive, wire, or spring clip.

In one embodiment, the jobber associates RFID tags with containers of product as they are received from the manufacturer. In this way, when an item is ordered from their customer, an employee simply has to retrieve the already tagged container from the warehouse.

Alternatively, the jobber may associate the RFID tags with containers of product as orders are received from a customer. In this embodiment, the containers retrieved from inventory do not have associated RFID tags. When an order is received, an RFID tag is issued with the ordered product and the tag may be programmed with data identifying the customer.

At Step 105, the container is delivered to the customer and at Step 110, the customer places the container in inventory.

During the course of business, the customer will remove containers of product from their inventory at Step 115. When a container is removed from inventory, the RFID tag is removed from the associated container and read by the RFID interrogator 33 at Step 120. In one embodiment, the tag is read by pushing the tag through a slot in the lid portion 42 of the enclosure 40 and past the RFID interrogator 33 as generally described above. After being read, the tag drops to the bottom of the enclosure 40 and may be discarded at the end of the day.

To prevent multiple orders for the same tag, the reorder computer 34 or the RFID interrogator may be programmed to receive data from an RFID tag only once based on the tag's unique identification number. In addition or alternatively, the RFID tag may be disabled after the data is read. In one embodiment, the RFID tag is disabled by transmitting a high energy RF signal at the tag such that the RFID circuitry is burned out. In an alternative embodiment, the tag is physically destroyed using a document destruction device. In a further embodiment, indicia are placed on the RFID tag to indicate that the tag has already been read.

At Step 125, the data read by the RFID interrogator is communicated to the reorder computer 34 and at Step 130, a replenishment order is placed with the jobber. In one embodiment, the reorder computer 34 consolidates all of the data read for a single day and communicates a single order to the fulfillment system 22 of jobber. Alternatively, the reorder computer 34 may send an order to the jobber as the information is received, or the data may be consolidated and sent periodically throughout the day. In a further embodiment, the RFID interrogator communicates the data read directly to the order fulfillment system of the jobber. In this embodiment, the order fulfillment system may consolidate the orders and generate a single set of documents for replenishing multiple products.

At Step 135, the jobber receives the reorder data via the order fulfillment system 22 and documents are generated to facilitate gathering items to fulfill the order for shipment to the customer. In one embodiment, the order processing system 24 generates a list of items for an individual to gather from the jobber's warehouse 20 for shipment to the customer. In a preferred embodiment, the order processing system 24 cooperates with the RFID read/write device 23 such that RFID tickets are processed with the documents generated. Therefore, the individual picking the order can also affix or otherwise associate RFID tags with the products being picked. In a further embodiment, the RFID tags could be used independently to gather the ordered items without generating a separate pick list.

Call for Help Embodiments

In addition to replenishing product, embodiments of the present invention may also be used to “call for help.” Often, a technician or employee will encounter a problem that requires technical assistance from a supplier or other outside company having technical expertise. The problem may arise in several different contexts. For example, a fork truck driver may have an issue with his fork truck, an assembly line worker may have an issue with a component part, or a collision repair technician may have an issue matching a specific paint color. In all of these instances, resolution of the issue may require assistance from an individual having technical expertise.

“Call for help” embodiments of the present invention will now be described with regard to a collision repair facility; however, it should be understood that the present invention may be used in connection with any business in which an individual needs to communicate with an individual with technical expertise to resolve an issue. The individual may be from an outside company such as a supplier, a jobber, a maintenance organization. Alternatively, the individual may be an in-house person having technical expertise.

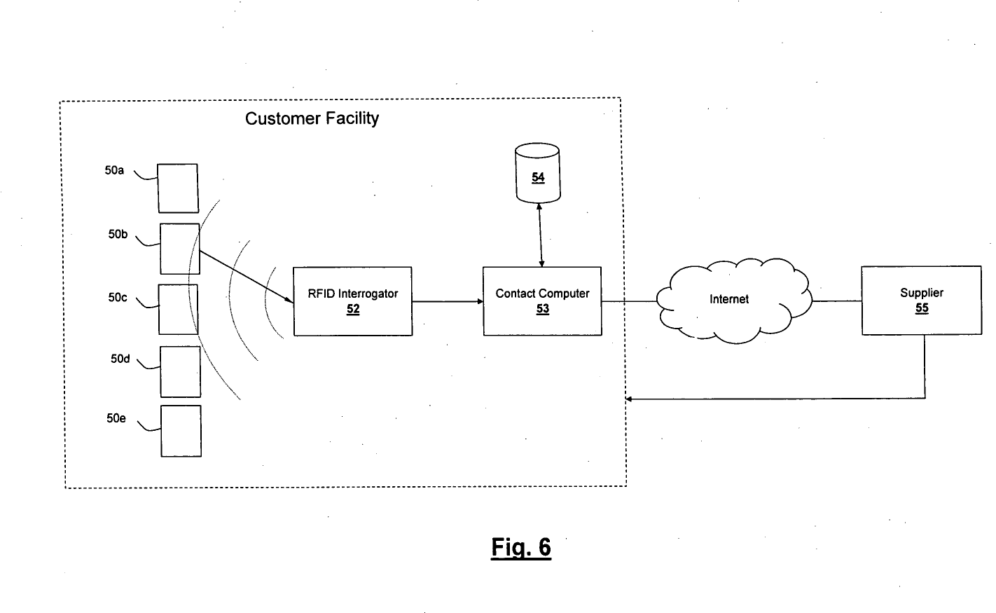

FIG. 6 provides a schematic diagram of an embodiment of the present invention. This embodiment includes RFID tags 50a-e associated with the customer's suppliers or jobbers, an RFID interrogator 52, a contact computer 53 associated with the RFID interrogator 52. The contact computer 53 may have architecture similar to that described with reference to the reorder computer discussed above.

In this embodiment, when a technician needs assistance from a supplier or jobber 55, he retrieves the RFID tag 50a associated with the supplier 55, and positions the tag near the RFID interrogator 52 so that it can be read. After the tag 50a is read, a predetermined message or alert is sent by the contact computer 53 to the associated supplier or jobber 55. The message or alert may be a prerecorded phone message, an email or a facsimile. Upon receiving the alert, the supplier or jobber 55 will preferably call a designated contact person at the customer to resolve the issue.

As one of ordinary skill in the art will appreciate, the RFID tags 50a-e may be associated with suppliers or jobbers in several different ways. For example, the RFID tag 50a-e may be programmed with the contact information for an associated supplier or jobber. Alternatively, the tag's unique identification number may be associated with the supplier or jobber in a database 54 accessed by the contact computer 53. In both cases, the RFID tags 50a-e preferably include some human readable indicia identifying the associated supplier, jobber and/or the types of products supplied. Thus, the technician can readily locate the appropriate tag when an issue arises. Alternatively, the RFID tags 50a-e may be positioned on a board (not shown) with indicia on the board associating the tag with a supplier or jobber or types of products supplied.

The RFID interrogator 52 may be placed in any accessible area such that a technician can retrieve the RFID tag 50a-e, place it near the RFID interrogator 52 so it may be read and then replace the tag 50a-e. Preferably, the interrogator 52 will provide an audible or visible indication that the RFID tag has been read and an alert sent.

In one embodiment, the RFID tags are low frequency tags with relatively short read ranges (e.g., less than 18 inches). In this way, RFID tags for different jobbers or suppliers are not read inadvertently.

In another embodiment, long range RFID interrogators are used and the tags are shielded until technical assistance is needed as opposed to short range interrogators that require positioning the tags near the interrogator to be read. In this embodiment, a technician removes the shielding thereby allowing interrogation of the tag. Once the return signal is received from the tag by the interrogator, an alert is sent to the associated supplier or jobber. In one embodiment, the RFID tags include an LED that illuminates when the tag is read. Thus, the technician knows when that a call for help process has been initiated.

In one embodiment shown in FIG. 6, the RFID tags 50a-e utilize high frequency signals that have a relatively high read range (e.g., 10 feet or greater). To read these tags, one or more RFID interrogators 52 are positioned in the customer's shop such that the interrogation range of the one or more RFID interrogators covers an area large enough to read all of the call for help RFID tags 50a-e. This area may be relatively small such as when the tags are located on a single display board in the customer's facility or may be relatively large such as when the tags are positioned near several work locations throughout a facility.

Because the interrogation range of this embodiment of the present invention encompasses more than one RFID tags (e.g., tags 50a-e), each of the RFID tags is shielded until technical assistance is desired. In one embodiment, the tags are placed in a metal container to shield them from the RF signals. However, as will be appreciated by those skilled in the art, the container may be constructed of any RF signal absorbing or deflecting material known or developed.

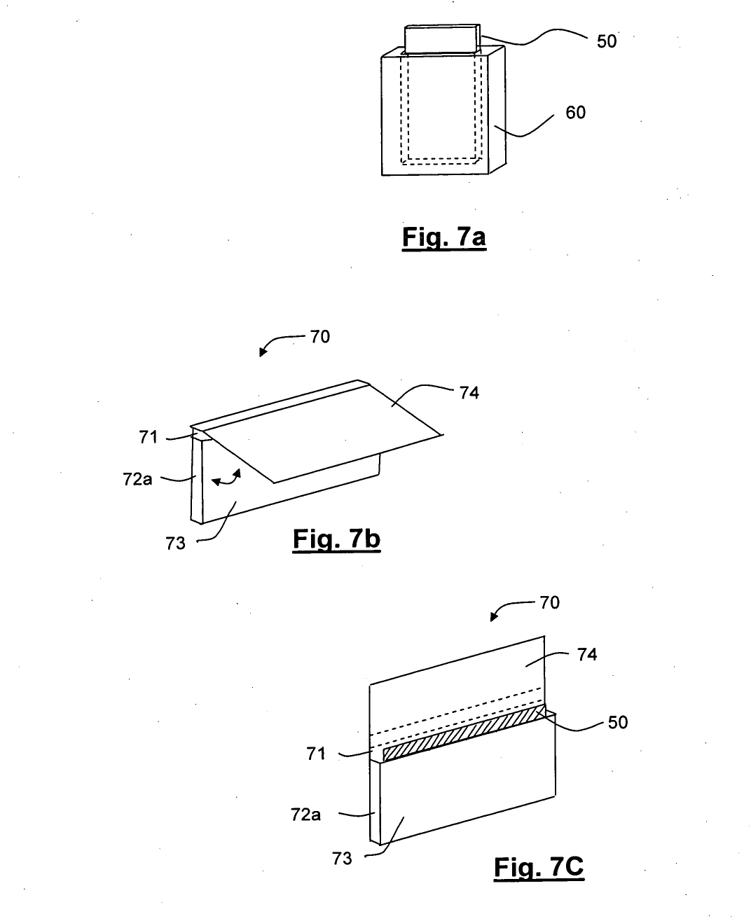

FIGS. 7a-c illustrate two exemplary shielding devices that may be used in connection with this embodiment of the present invention. In FIG. 4a, an RFID tag 50 is slid into a metal container 60 such that the tag's antenna is within the container 60. In this way, the antenna of the RFID tag 50 cannot receive an RF signal from the RFID interrogator 52.

In FIGS. 4b-c, a metal container 20 having a foldable flap is illustrated. This container 20 is configured to hold an RFID tag 50 and includes a rear panel 71, two side panels 72a-b, a front panel 73 and a flap 74. In one embodiment, the rear panel 71, the two side panels 72a-b and the flap 74 are constructed of a material that prevents the transmission of RF signals such as metal and the front panel 73 is constructed of a material that allows the transmission of RF signals such as plastic. When the flap 74 is closed, the RFID tag 50 is surrounded by metal and cannot receive an RF signal. However, when the flap 75 is open, the tag can receive signals because the front panel 72 is plastic and does not deflect the RFID interrogator's signals.

Returning to FIG. 6, in operation, the RFID interrogator 52 periodically polls the tags 50a-e to determine if the shielding has been removed. If the shielding has been removed, a return signal is received and the interrogator communicates this event to the contact computer 53 which sends an alert to the associated outside company with technical expertise. Otherwise, no return signal is received due to the shielding and no alert is sent.

### CONCLUSION

In concluding the detailed description, those skilled in the art will understand that many variations and modifications can be made to the embodiments described herein without substantially departing from the principles of the present invention. Also, such variations and modifications are intended to be included within the scope of the present invention.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention.

That which is claimed:

1. A replenishment system comprising:
an order fulfillment system configured to associated an RFID tag with a product wherein said product interferes with communication via radio signals; and
a reorder system comprising:
an RFID interrogation device configured to read said RFID tag after it has been removed from said product; and
a reorder computer configured to place an order for replenishment of said product based in part on said interrogated RFID tag.

2. The system of claim 1, wherein said order fulfillment system is configured to write the name of a customer receiving said product to said RFID tag.

3. The system of claim 1, wherein said RFID interrogation device is configured to disable said tag after reading it.

4. The system of claim 1 further comprising an enclosure housing said RFID interrogation device and having an aperture sized to accept said RFID tag wherein said aperture is positioned to direct said RFID tag proximate said RFID interrogation device to facilitate interrogation.

5. The system of claim 4 further comprising a document destruction device housed in said enclosure and configured to destroy said RFID tag after it is read by said RFID interrogation device.

6. The system of claim 4 further comprising a marking device configured to mark said RFID tag after said RFID interrogation device has read said RFID tag.

7. A method of replenishing a product comprising the steps of:
receiving a product with an associated RFID tag wherein said product impedes communication between with said RFID tag;
placing said product in inventory;
retrieving said product from inventory as needed;
removing said RFID tag such that said RFID tag can be read by an RFID interrogator;
interrogating said RFID tag; and
placing an order for replacement quantities of said product based at least in part on said interrogating step.

8. The method of claim 7, wherein said product is a liquid.

9. The method of claim 7, further comprising the step of disabling said RFID tag by sending a high energy radio frequency signal to burnout the associated RFID circuitry in the RFID tag after the RFID tag has been read.

10. The method of claim 7, further comprising the step disabling said RFID tag by physically destroying said RFID tag after the RFID tag has been read.

11. An apparatus for interrogating RFID tags comprising:
an enclosure having a removeable lid and an aperture sized to accept an RFID tag;
an RFID interrogator positioned inside said enclosure; and
a receptacle positioned inside said box and configured to receive RFID tags after they are interrogated by said RFID interrogator.

12. The apparatus of claim 11 further comprising a marking tool configured to place indicia on said RFID tag indicating said RFID tag has been interrogated by said RFID interrogator.

13. The apparatus of claim 11 further comprising a device positioned in said enclosure and configured to disable said RFID tag.

14. The apparatus of claim 13, wherein said device sends a high energy RF signal to disable said RFID tag.

15. The apparatus of claim 13, wherein said device physically destroys said RFID tag.

16. A system for providing technical assistance comprising:
an RFID tag associated with an entity capable of providing technical assistance;
a shielding device configured to selectively prevent said RFID tag from being read;
an RFID interrogator configured to detect when said RFID tag has been removed from said shielding device; and
a contact computer associated with said RFID interrogator and configured to send a message to said entity based at least in part on communication between said RFID interrogator and said RFID tag.

17. The system of claim 16, wherein said message is an email message.

18. The system of claim 16, wherein said contact computer is configured to initiate a telephone connection with said entity and to play a prerecorded message.

19. The system of claim 16, wherein said shielding device comprises an enclosure having a portion that may be selectively opened to allow interrogation of said RFID tag by said RFID interrogator.

20. The system of claim 16, wherein said RF signal shielding device defines a bore sized to accept said RFID tag.

21. A system for providing technical assistance comprising:
a plurality of RFID tags associated with a plurality of entities capable of providing technical assistance;
a plurality of shielding devices configured to selectively prevent said plurality of RFID tags from being read;
an RFID interrogator configured to poll said RFID tags and to identify a select RFID tag when said select RFID tag has been unshielded; and
a contact computer associated with said RFID interrogator and configured to send a message to an entity associated with said select RFID tag based at least in part on communication between said RFID interrogator and said RFID tag.

22. The system of claim 21, wherein said communication between said RFID interrogator and said RFID tag comprises sending a unique identification number.

23. A method of requesting technical assistance comprising the steps of:
associating an RFID tag with an entity capable of providing technical assistance;
shielding said RFID tag to selectively prevent interrogation of said RFID tag;
unshielding said RFID tag to allow said RFID tag to be interrogated; and
sending a message to said entity based at least in part on said interrogation.

24. The method of claim 23, wherein said step of sending a message comprises sending an email message.

25. The method of claim 23, wherein said step of sending a message comprise initiating a telephone connection and playing a prerecorded message.
